(19) United States
(12) Patent Application Publication
(10) Pub. No.: US 2002/0099591 A1
(43) Pub. Date: Jul. 25, 2002

(54) Computer assisted sustainability testing

(76) Inventor: William Richard Dyer, Plano, TX (US)

Correspondence Address: ROTHWELL, FIGG, ERNST & MANBECK, P.C., 1425 K STREET, N.W., SUITE 800, WASHINGTON, DC, 20005, US

(21) Appl. No.: 09/764,338

(22) Filed: Jan. 19, 2001

(51) Int. Cl. G06F 17/60

(52) U.S. Cl. 705/10

(57) ABSTRACT

The present invention is a method for an online sustainability test. The method produces results for a base wave of a sustainability test by presenting an item to a user over a distributed network, presenting a questionnaire to the user over the distributed network if the user selects the item, and accepting and storing the user's response to the questionnaire. To get results for later waves of the sustainability test, the questionnaire is presented again to the user if the user later selects the item again. Results for the sustainability testing are produced by identifying trends and changes in the user's responses to the questionnaire.

### FIELD OF THE INVENTION

The present invention relates to the field of product evaluation by consumers. More particularly, the invention provides a system and method for determining consumer preferences and product longevity over a distributed network such as the Internet.

### BACKGROUND OF THE INVENTION

It is well known to survey customers in order to refine and improve products, and more specifically, sustainability testing of new products is well known. For example, U.S. Pat. No. 5,090,734 (the “'734 patent”), issued to the inventor of the present application, teaches a product testing method characterized as a product attribute and repeat test (“PAR”). The disclosure of the '734 patent is hereby incorporated by reference in full.

To briefly summarize the '734 patent, a method is provided to evaluate consumer goods by selecting a plurality of test panel members to receive a set of test materials from a source. An evaluation is conducted by providing each test panel member with the set of test materials over several cycles or “waves,” so that product preferences and purchasing trends can be evaluated over time. In the context of snack food evaluation, the test materials comprise a set of food products to be evaluated by the consumer (an “evaluation set”), a video tape containing a video presentation on each food product in the evaluation set, and means for ordering one or more food products (of the panel member's choosing) from the evaluation set. The evaluation set of food products may comprise a number of subsets; a set of experimental or test food products being evaluated (the “test set”), and a set of currently-marketed commercial food products (the “market set”) which the test panel member will already be familiar with.

The product evaluation process is carried out in a plurality of cycles or “waves.” In the first cycle (the “base wave”) the test panel receives information regarding and means for ordering products from an evaluation set comprising only the market set. In subsequent waves, the test panel member receives information and means for ordering products from an evaluation set consisting of the union of the market set and the test set. Samples of the test set products may be included among the test materials provided to the test panel member during these subsequent waves.

Each panel member is instructed to respond to the test by sampling the test food products and to utilize the ordering means to order a stated number of food products from the evaluation set. A panel member's food product preferences are evaluated by recording the identity of the food products ordered in response to each wave of the test. The products ordered during the base wave provide baseline data regarding the test panel members preferences. The products ordered during subsequent waves reflects the ability of the test products to “win over” the consumer and succeed in the competitive marketplace.

However, known sustainability testing techniques, such as the above described method, are relatively expensive to perform because the testing lasts for an extended period. For example, as described above, a sustainability test generally requires extended activity by the testing company so that the product is tested through several waves. This extended activity is needed because the testing looks at changes in consumer opinions over time.

Furthermore, the known methods for sustainability testing require active participation by test subjects over an extended period, making compliance in the study difficult for the consumers. The sustainability testing results can be skewed if consumers only partially comply with the testing parameters.

Another shortcoming to currently employed sustainability testing methods is the necessity to change the distribution flow for the test product. For example, the test product is typically limited to a small test area under controlled conditions to preserve the accuracy of the test, and therefore, a product under testing can only be provided to specific stores in specific areas. As a result, traditional sustainability tests require the creation of a special distribution system for the test product. This complicates business operations, and a more desirable testing method would employ existing infrastructures to make the testing more simple to execute.

Also, sustainability testing techniques have not been adapted to test online customers. Online business or “e-commerce” represents a rapidly growing segment of the economy.

Traditionally, vendors have presented product information to consumers through printed catalogs. The printed catalogs contained images and descriptions of the vendors' items, as well as information on how to purchase the items from the vendor. Through advancement in technology, it has recently become possible to display images and product information over a distributed network, such as the Internet, in the form of an electronic catalog.

An online catalog is an electronically stored collection of product information. The product information is then provided to customers over a distributed network so that the customers may access the product information from afar. For example, product information may be electronically mailed to the customers.

Typically, an electronic catalog sends the product information to customers through a series of “client-server” transactions. The client-server model of interaction in a distributed network is a system in which a program at one site sends a request to a program at another site and waits for a response. The requesting program is called the “client,” and the program that responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.” The web server is said to “serve” the client by transmitting data over the network to the user's computer for viewing through the browser. Upon establishing a connection to the distributed network, the browser is assigned a unique set of numbers “C” that identify the client. The server also has a unique identifying set of numbers “S.” Furthermore, each page of information has a unique identifier “P.” Accordingly, a request from the browser to the server is generally in form of: server S, please send information P to client C. The request may be routed through the network using the server's identifier S. Alternatively, every server throughout the network may receive the message, with only server S replying to the request. The server S then responds to the request by sending out information P to client C. Again the information P may be sent only to client C by routing the information P through the network or the information P may be transmitted throughout the network with only client C accepting the information.

The data served from the client to the server is interpreted by the browser to form a webpage that displays the data for easier use by the user. A webpage typically contains at least one “hyperlink,” a navigational link from one document to another, or from one portion (or component) of a document to another. Typically, a hyperlink is displayed as a highlighted word or phrase that can be selected by clicking on it using a mouse to jump to the associated document or documented portion. Hyperlinks are used to form a series of connected webpages in a “hypertext System,” a computer-based informational system in which documents (and possibly other types of data entities) are linked together via hyperlinks to form a user-navigable “web.”

The terms World Wide Web (hereafter “Web”) is used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML (discussed below). However, the terms “Web” and “World Wide Web” are intended to encompass future markup languages and transport protocols which may be used in place of (or in addition to) HTML and HTTP.

The largest component of the Web is the Internet, a collection of interconnected (public and/or private) networks that are linked together by a set of standard protocols (such as TCP/IP and HTTP) to form a global, distributed network. While this term is intended to refer to what is now commonly known as the “Internet,” it is also intended to encompass variations which may be made in the future, including changes and additions to existing standard protocols.

In the context of a server-client interaction, a website is a computer system that serves informational content over a network using the standard protocols of the World Wide Web. Typically, a website corresponds to a particular Internet domain name, such as “www.fritolay.com,” and includes the content associated with a particular organization. As used herein, the term is generally intended to encompass both (i) the hardware/software server components that serve the informational content over the network, and (ii) the “back end” hardware/software components, including any nonstandard or specialized components, that interact with the server components to perform services for Web site users.

An online document, such as a catalog, can be identified and found using its Uniform Resource Locator (URL), a unique address which fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

Hyper-Text Markup Language, or “HTML,” is a standard coding convention and set of codes for attaching presentation and linking attributes to informational content within documents. HTML 4.0 is currently the primary standard used for generating Web documents, but it should be appreciated that new versions of HTML are constantly being developed to accommodate the changing needs of the Web. During a document authoring stage, the HTML codes (referred to as “tags”) are embedded within the informational content of the document. When the Web document (or HTML document) is subsequently transferred from a Web server to a browser at a client, the codes are interpreted by the browser and used to parse and display the document. Additionally in specifying how the Web browser is to display the document, HTML tags can be used to create hyperlinks to other Web documents, as described above.

Hypertext Transport Protocol (“HTTP”) is the current standard World Wide Web client-server protocol used for the exchange of information (such as HTML documents, and client requests for such documents) between a browser at a client and a Web server. HTTP includes a number of different types of messages which can be sent from the client to the server to request different types of server actions. For example, a “GET” message causes the server to return the document or file located at the specified URL.

Electronic catalogs thereby allow vendors to present items to users without incurring printing and mailing costs, allowing the vendor to reach more users without increasing costs. Furthermore, online catalogs allow new customers to locate the vendor and to access a vendor's product information, thereby allowing the vendor to market to new users without significant additional costs. However, businesses have not used online catalogs to implement sustainability testing.

### SUMMARY OF THE INVENTION

It is therefore a goal of the present invention to provide a methodology for surveying customers over a distributed network, such as the Internet. The method produces results for an initial and subsequent waves of a sustainability test by presenting an item to a user over a distributed network. Questionnaires can be administered at the initial or any other subsequent interaction. The user's response if tallied over a set amount of time to determine the sustainability of the product and the products interaction with all other products being offered. Thereby the results for the sustainability testing are produced by identifying trends and changes in the user's responses and answers to the questionnaire.

### BRIEF DESCRIPTION OF THE DRAWINGS

The features and advantages of the present invention are more fully described in the attached drawings in which corresponding elements are designated by like reference numbers and in which:

FIG. 1 is a flow chart diagram of a method for computer assisted sustainability testing in accordance with an embodiment of the present invention;

FIG. 2 is a flow chart diagram of an exemplary process to present a product in accordance with an embodiment of the computer assisted sustainability testing method of FIG. 1;

FIG. 3a-b are flow chart diagrams of exemplary processes to present a questionnaire in accordance with embodiments of the computer assisted sustainability testing method of FIG. 1;

FIG. 4 is an illustration of an exemplary questionnaire in accordance with an embodiment of the present invention;

FIG. 5.is a flow chart diagram of an exemplary process to accept and store the user's response to the questionnaire in accordance with an embodiment of the computer assisted sustainability testing method of FIG. 1.

### DETAILED DESCRIPTIONS OF THE INVENTION

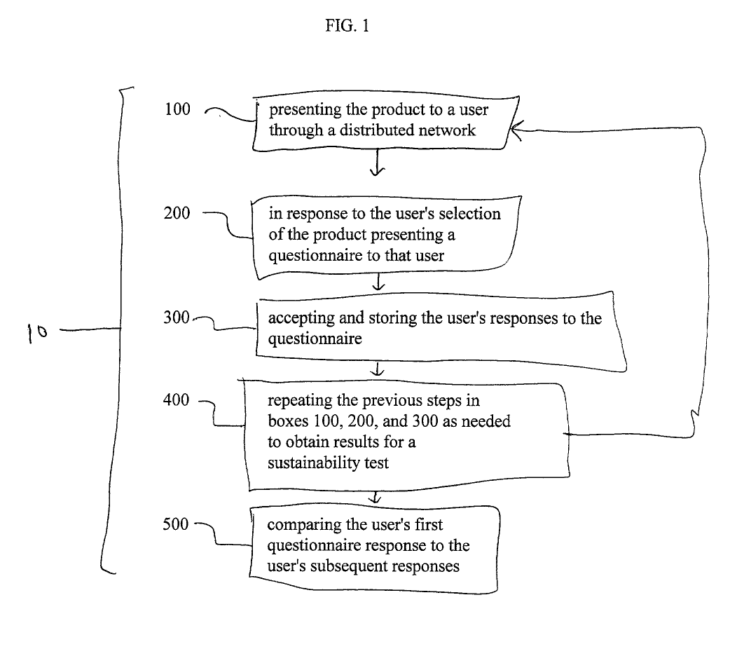

The present invention provides for computer assisted sustainability testing (“CAST”) over a distributed network such as the Internet. In accordance with the present invention, FIG. 1 illustrates a CAST method 10 for surveying customers over a distributed network in order to perform a sustainability test. The CAST method 10 according to the present invention involves the steps of (1) presenting the product to a user through a distributed network, box 100; (2) presenting a choice of purchase and/or a questionnaire to that user in response to the user's selection of the product, box 200; (3) accepting and storing the user's responses to the purchase and/or questionnaire, box 300; (4) repeating the previous steps in boxes 100, 200, and 300 as needed to obtain results for a sustainability test, box 400; and (5) comparing the user's first response to the user's subsequent responses, box 500. The individual steps on the CAST method 10 are now described in greater detail.

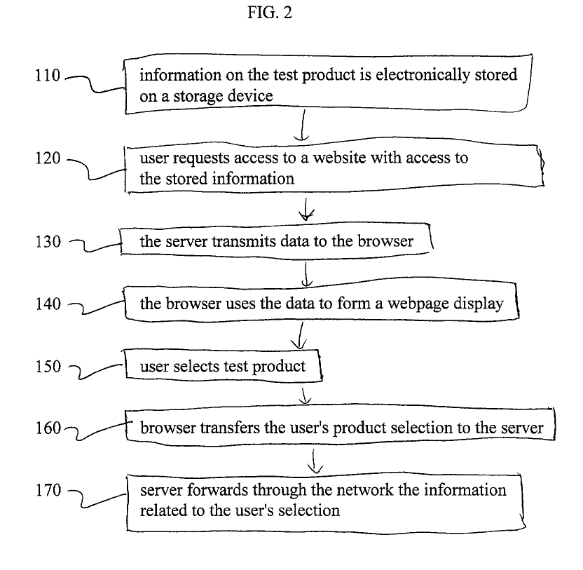

The first step of the CAST method 10 is to present the test product to a user through a distributed network such as the Internet, box 100. As previously described, online catalogs are well known in the art, and the test product may be presented to the user through a series of client-server transactions. A typical online data transfer of product information using client-server transactions is briefly summarized in FIG. 2. To begin the process, information on the test product is electronically stored on a storage device such as a hard drive or CD-ROM or in computer memory such as RAM/EPROM, box 110. As part of this step, a server is electronically connected for access to the stored product information. The storage device may be directly connected to the server, or the server may have access to an independently located storage device. For example, the server may access stored information over a distributed network by requesting the information from a second server. In this way, information may rapidly cascade through a distributed network, even if the information was originally located in only a single location. The server then provides the stored product information over a distributed network while serving the contents of the online vendor's website to the user's browser.

The user then “requests” access to the online vendor's website by specifying the domain name for the vendor's website through the browser, box 120. The user may either manually enter the location for the website or select a hyperlink that directs the user's browser to the website's domain. For example, it is well known in field of e-commerce to have virtual shopping centers that identify several online vendors and provide hyperlinks to the website for each of the online vendors. The user may then select one of the hyperlinks to be redirected to the website for the desired online vendor.

Upon receiving the user's request for the website, the server transmits data to the browser, box 130, whereby the browser uses the data to form a webpage display, box 140. As described above, the data from the server is generally in the form of HTML codes that specify the appearance for the webpage, along with various designated images and sounds used to complete the “hypermedia” presentation through the user's browser. The webpage for the online vendor generally identifies the vendor and the products carried by the vendor. An online catalog typically lists several products, each of which has a separate hyperlink that specifies a URL containing additional data on the product. The webpage also generally contains several hyperlinks that direct the user to webpages to view more information on the product, such as information on the products of the vendor, to make an order, to submit a question to the vendor, and to view the status of a previously submitted order to the vendor.

The user may then request information on a specific product, box 150. For example, the user may select a hyperlink associated with the product by providing an input designating the specific product, such as clicking on the desired product with a mouse or other similar pointing device. The browser transfers the user's product selection to the server to request additional information on the selected product, box 160. On the Internet, the browser's request for the information is in form of a GET:URL command in HTTP that requests information stored at the specified Web address in the hyperlink.

As before, the server responds to the request from the browser by forwarding through the network the information contained at the specified URL, box 170.

In the present invention, the product information requested by the user may comprise numerous different aspects. For example, the information may be a more detailed description of the product, an image of the product, the pricing for the product, warranty information, instructions to purchase the test product, information on the manufacturer, ratings provided by other users or professional reviewers, comparisons to related products, etc.

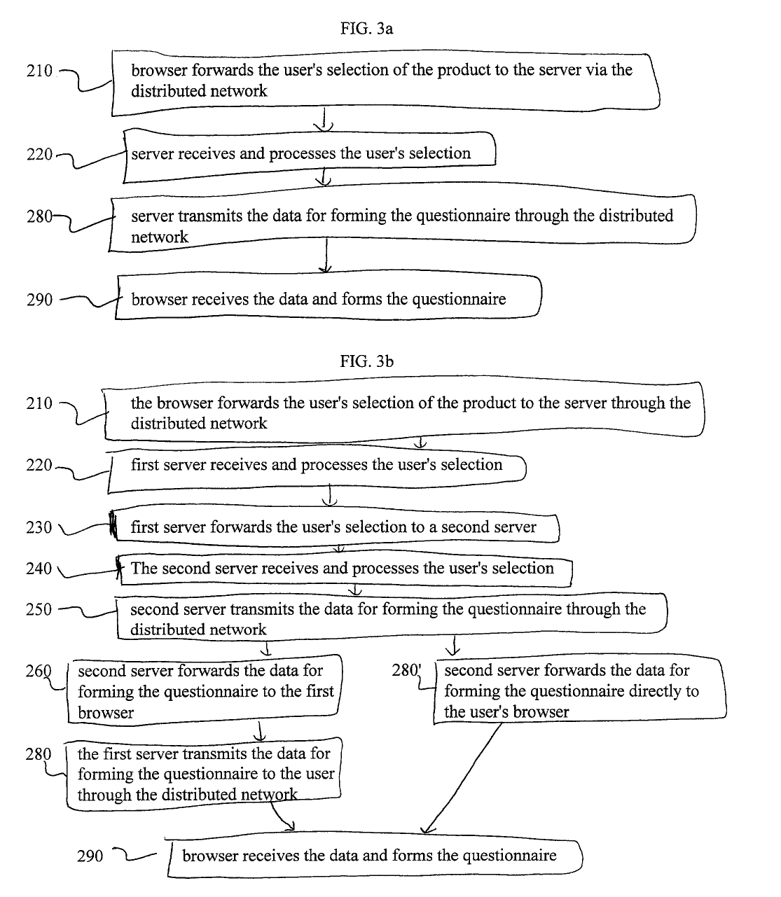

Once the user has selected the test product in the step of box 100, a questionnaire is presented to the user, box 200. The questionnaire may be included as part of the data stored at the URL associated with the test product on the online catalog. In this case, the browser receives the questionnaire as part of the HTML data sent from the server to the user's browser. When the browser forms a webpage with the data from the server, the questionnaire is presented to the user by the browser along with the product information. The process is summarized in FIG. 3a, in which the browser forwards the user's selection of the product to the server via the distributed network, box 210. The server receives and processes the user's selection, box 220, and then, the server responds to the request by automatically transmitting the data for forming the questionnaire to the user through the distributed network, box 280. The user's browser receives the data and forms the questionnaire for viewing by the user, box 290.

Similarly, the server may redirect the user to a second location that contains the questionnaire. Selection of the test product may result in the user being redirected to a separate website containing the questionnaire. The first server accesses and obtains the questionnaire information from the second server on the network, and then forwards the information to the user's browser. This process is summarized in FIG. 3b. As part of this process, the browser forwards the user's selection of the product to the server through the distributed network, box 210. Then the server receives and processes the user's selection, box 220, and forwards the user's selection to a second server, box 230. In effect, the first server acts as a client that requests the transmission of data by the second server in the form of a GET command in HTTP. The second server receives and processes the user's selection, box 240, and then can respond to the request by automatically transmitting the data for forming the questionnaire through the distributed network, box 250. At this point, the second server forwards the data for forming the questionnaire either to the first browser, box 260, or directly to the user's browser, box 280′. If the questionnaire data is first forwarded to the first server, then the first server transmits the data for forming the questionnaire to the user through the distributed network, box 280. In either case, the user's browser receives the data and forms the questionnaire, box 290. All of these processes occur as described above through the typical server-client transactions.

The questionnaire may appear as a series of separate questions, where the browser presents each question and returns the user's response to the server to initiate a subsequent question. In effect, each question is then a separate webpage served from the client-browser, and each response is a request from the client for a new question from the server. In this way, a questionnaire may be designed so to minimize reputation and illogical questions based upon the response to previous questions. For example, if the user indicates that she is unmarried, the questionnaire could skip questions about the user's nonexistent spouse. In this form, the questionnaire is generally a C program executable that operates on the server, or other connected computer, to specify the question to be presented to the user and to process the user's replies. In this situation, each question response is a separate variable in the C program and will be processed and stored accordingly.

Alternatively, the questionnaire may contain several questions that are presented together to the user. For example, the questionnaire may be a series of text boxes with input areas or drop down menus from which the user may select a desired answer. Once the user has provided the answers to all of the questions, then the browser forwards the whole set of the user's answers to the questionnaire to the server for storage and processing, as described in more detail below. In this embodiment, the questionnaire may again be a C program that executes on the server to forward questions to the user's browser. In this implementation, the questions and answers are instead transmitted from the browser simultaneously in a contiguous block of data. Transferring a set of questions or a set of responses in a single transaction over the network is advantageous in comparison to a series of data transfers over the network because a series of small data transfers over a network takes more time than a single large data transfer to transmit the same amount of data. In particular, a time delay occurs with every data transfer over a network as a connection is established between the client and server.

In an alternative preferred embodiment, the step of forwarding the questionnaire to the user, box 200, is accomplished by serving an executable program to the user's computer. Once the program is received at the user's computer, the server may store the program or may access the program from another location on the network, such as a second server. After the program data is transmitted to and received by the browser, the browser interprets the data transmitted from the browser to form the program. The program is typically written in a cross-platform language that can execute through the browser, such as common gate interface (“CGI”) script/JAVA/PERL applets, so that the program may run on multiple types of computer and devices. The applet may run on the browser as part of the displayed webpage. Once the questionnaire program data is received and compiled by the browser, the program executes through the browser so that the questionnaire is presented to the user. Typically, the questionnaire will appear as a separate window, a displayed box on the user's computer in which a program operates, for viewing on a display device connected to the user's computer. The program operates to present the questionnaire and to accept the user's responses to the questions in the questionnaire.

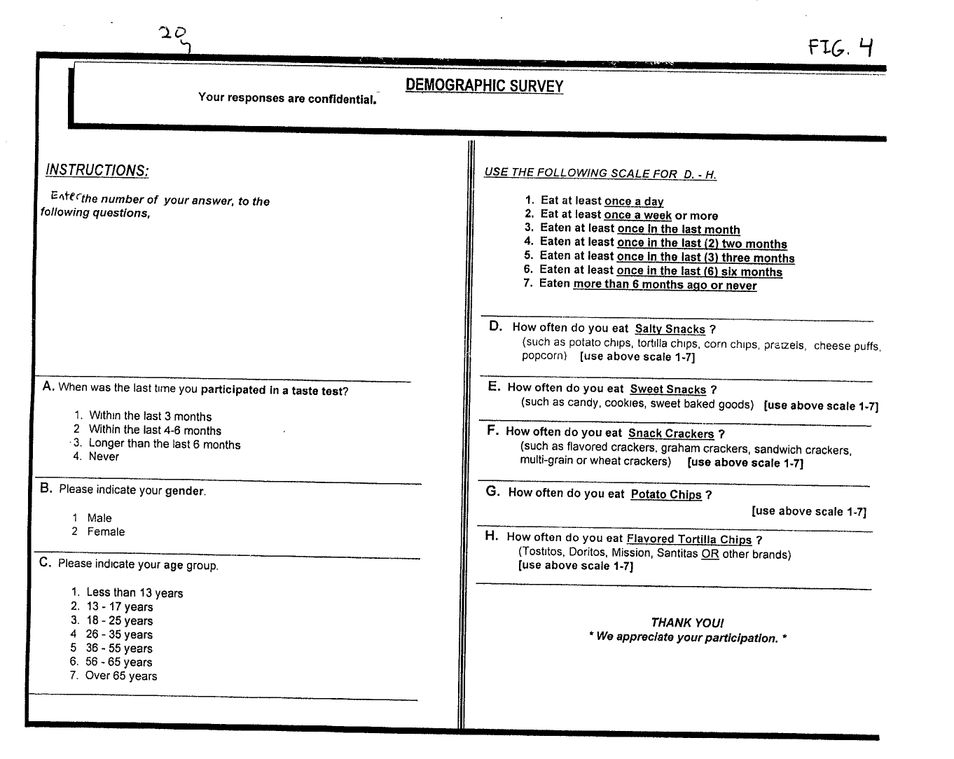

The questionnaire may ask various questions to the user, as needed for the sustainability study. These questions generally relate to the user's opinion of the product and reasons for selecting the product. For example, the user may be asked to provide a numerical rating for the test product, along with identifying/selecting any strengths or weakness to the products. The questionnaire may further inquire for personal information to identify the user and to improve the statistical interpretation of results of the sustainability testing. For example, a user may be asked to provide her zip code or area code, her income level, her age, her ethnicity, etc. An exemplary questionnaire 20 is illustrated in FIG. 4.

In one embodiment, a cookie is assigned to the user's browser. Cookies are informational items stored on the user's computer (typically on the hard drive). The cookies enable a Web server to retrieve information from a user's computer that reveals prior browsing activities of the user. A cookie is typically a unique identifier that identifies the user's browser. The server has a database that stores a record of the online activities by the identified user at the website. When the user returns to the website, the server can identify the user through the cookie and then update the database to include the user's new activities. For example, the server may store the webpages viewed by the user, purchases made by the user, personal information previously submitted by the user, etc.

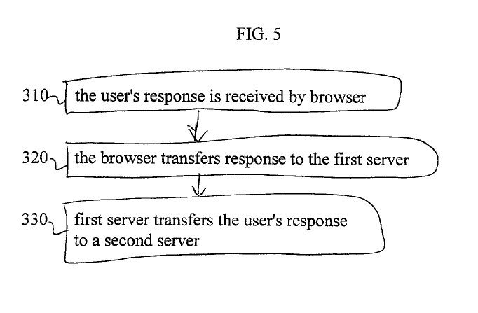

Once the user has completed the questionnaire regarding the test product, the next step is accepting and storing the user's responses to the questionnaire, box 300. As illustrated in FIG. 5, the user's response is first received by the browser, box 310. Upon receiving the user's response, the browser prepares the response for transfer back to the server, box 320. The user's response may be sent to the online vendor for collection or may be sent directly to the testing company, thereby preventing the online vendor from accessing the customers' confidential/valuable data. Therefore, the first server may transfer the user's response to a second server, box 330. For example, an online vendor may forward the user's reply to the producer of the test product. In this way, the test may be performed simultaneously through several sites, with the result being accumulated and analyzed at a single site. A manufacturer may provide the test product to multiple online vendors and collect sustainability testing results from all of vendor sites, even if the same user purchases the test item from different vendors.

In a preferred embodiment, the user's browser transmits the response in Extensible Markup Language (“XML”) in accordance with the instructions/applet received from the server. XML is a web language similar to HTML, but the XML is a markup language for describing data whereas HTML primarily is a markup language for describing text and picture layouts (hypertext). In particular, XML is more interactive and well suited for electronic commerce because the coding contains markers that simplify the standardization and exchange of information over the Internet. In particular, XML enables designers to create their own customized tags to provide functionality not available with HTML. For example, website designers may create a standard or common way to describe the product (price, size, color, and so forth) and then describe the product information with XML.

Once received by the server, the user's responses are typically stored in a database. The database allows easy access to and analysis of the user's responses.

After the user has completed the questionnaire and the results are received and stored by the server, the process of presenting the product to a user, box 100; presenting a questionnaire to that user in response to the user's selection of the product, box 200; and accepting and storing the user's responses to the questionnaire, box 300 is repeated. The user is generally not asked or required to repeat the test. Instead, the CAST method 100 works passively, so that a questionnaire is presented whenever the test item is selected. If the user again selects the test item and replies to the questionnaire, after having previously selected the test item and replying to the questionnaire, the user's new responses obtained and stored as previously described.

Then sustainability testing is performed on the test product by comparing the user's first questionnaire response to the user's subsequent responses, box 500, to determine changes in the user's perceptions and opinions of the test product. Sustainability testing looks to trends in users' opinions of the test product in order to predict the long term viability of the product.

More specifically, sustainability testing involves multiple waves of testing the same group of test subjects. In this way, sustainability testing evaluates a group's changing opinion of a product as the group becomes more familiar with the product. This data provides important information on changing trends in consumer opinion. For example, consumers may find that a product, although initially unappealing, may become more liked with increased use. Data showing increasing or consistently high customer preference for a product after an extended period of use is a good indicator that the product will have sustained commercial appeal. Conversely, testing showing a rapidly decreasing opinion of a product with increasing use is a good indicator that the product may not be commercially successful. Accordingly, the CAST method 10 provides a methodology to easily track changing consumer opinions on a test product.

Sustainability testing is especially valuable in consumer goods such as snack food products (potato chips, cookies, snack cakes, nuts, etc.). These types of products tend to be purchased more than once, thereby allowing the multiple testing waves needed for the sustainability testing. Also, the composition and taste of manufactured foods, such as snack products, may be varied greatly to accommodate changing tastes. Accordingly, sustainability testing maybe used to track the results of changes in consumer opinion in the products, even if the changes are minor.

In a sustainability test, consumer data among a broad, competitive set can be used to determine switching, allocation, and cannibalization of existing competitive and noncompetitive products. In this way, it can be determined if a new product will increase profits or merely cause consumers to switch from existing products, thereby producing no net increase in sales. Likewise, the consumer data may be used to determine the interrelationship between products. For example, a new snack food may reduce the sales of some existing snack foods, but may increase the sales of dipping sauces.

As part of analysis in step 500, the data collected through the CAST method 10 may be analyzed using various known statistical techniques. Many businesses already employ computer programs to analyze data collected from traditional customer surveys. These same programs may be used to evaluate the CAST data. Alternatively, numerous statistical analysis software packages are currently available, such as SAS, SAS Entriprise Miner, IBM DB2 Intelligent Miner, MiniTAB and Sinca'P from Umetrics.

In one embodiment, step 500 of the CAST method 10 further includes the use of a standard panel analysis package to determine other market effects so that augmentation or modeling of certain demographic groups may be done as needed. For example, computer users are more likely to be from urban areas than a random sampling of consumers. To evaluate the results of a CAST survey, data relating to the user's geographic location, such as zip codes information, may be used to check for geographic balance.

In another embodiment, the analysis of the questionnaire responses in step 500 may be manipulated using known statistical techniques, such as increasing the mathematical weight of the lesser represented groups of consumers. The same testing data may thereby be used in order to achieve more statistically meaningful results from the CAST method 10. This augmentation or modeling of the survey data prevents the CAST results from being skewed if responses are concentrated in certain groups of consumers, rather than a truly representative sample. In addition to different geographical location, adjustments may be made to the survey data to accommodate different levels of income, education, age, gender, race, etc. Adjustments may also be made for buying patterns such as heavy or little users, as well as previous product usage.

At the same time, any skew results in the data from the CAST testing provide important information for the purpose of predicting a product's long term viability. For example, if a large, commercially important demographic group consistently ignores a product, the product or its packaging may need to be redesigned to avoid long-term commercial failure.

Step 500 may further include a comparison of the results from CAST method 10 and traditional sustainability testing that is performed off-line, such as the method of the above-referenced U.S. Pat. No. 5,090,734. This comparison of online and offline test results gives valuable information about online consumers. In this way, a business new to the Internet may discover the differences between online customers and customer in traditional stores, thereby providing to the business valuable insight into the virtual marketplace, one of the fastest growing segments of the economy.

Overall, the CAST method 10 combines the statistical usefulness of sustainability testing with the efficiencies of access over a computer network. In particular, CAST method 10 achieves the results of known sustainability testing with the efficiencies of online shopping to create a virtual test market. The present invention therefore retains the efficiencies and costs of consumer testing while retaining the benefits of sustainability measures.

Online vendors may employ the CAST method 10 by merely adding the new product to the vendor's site and by polling customers in the above described methods. In the alternative, the producer may provide the test product through third-party, online vendors. In order to encourage online vendors to participate in the CAST method 10, the test product may be provided exclusively through the online vendors, thereby allowing the online vendors to offer unique products that are not otherwise available to the public. The test product may optionally be provided at no charge to the online vendor. Alternatively, a company may allow the sale of popular existing products through the online vendor in exchange for the online vendor's participation in the CAST method 10. A company testing a product through the CAST method 10 may also offer to share the test results with participating online vendors, thereby sharing the unique insights to online customers discovered through CAST, allowing the online vendors to better serve their customers. Therefore, the CAST method 10 allows a producer to develop partnerships with online Internet vendors.

Using CAST method 10, a test product may be delivered through an existing external infrastructure, thereby making the sustainability test more simple to execute. For example, a product ordered through an online vendor can be delivered through the online vendor's standard delivery protocols.

In an alternative embodiment, several products may be tested together using the CAST method 10. For example, a dipping sauce may be tested along with a particular snack food. The questionnaire is then adapted to include questions comparing the multiple test products or inquiring into the customer's association of the products. Similarly, the server may not present the questionnaire to the user unless the user selects each of the products under testing. In this way, the CAST method 10 may also allow several business to test their products together to see how the products coexist. This functionality helps the businesses to predict the effectiveness of co-branding and joint marketing.

Having described the invention, it will be apparent to those skilled in the art that the same may be varied in many ways without departing from the spirit and scope of the invention. Any and all such modifications are intended to be included within the scope of the following claims.

What is claimed is:

1. A method for surveying an online user comprising the steps of:
(1) presenting a first item to the user over a distributed network;
(2) presenting a questionnaire to the user over the distributed network if the user selects the first item;
(3) accepting and storing the user's first response to the questionnaire;
(4) repeating, at least one time, steps 1-2 and accepting and storing the user's subsequent response(s) to the questionnaire; and
(5) performing online sustainability testing by comparing the user's first response to the user's subsequent response(s).

2. The method of claim 1, wherein the step of performing online sustainability testing further comprises correcting or correction for a skewed result.

3. The method of claim 1, wherein the step of presenting a first item further comprises presenting a second item and wherein the questionnaire asks about the first and second items.

4. The method of claim 3, wherein the step of presenting a questionnaire to the user only occurs if the user selects both the first and second items.

5. The method of claim 1 wherein the distributed network is the Internet.

6. The method of claim 1 wherein the step of presenting a first item to the user is done by a first entity and the step of performing online sustainability testing is done by a second entity.

7. The method of claim 6, wherein the first entity is an online vendor and the second entity is a producer of the item.

8. The method of claim 7, wherein the producer shares results from the online sustainability testing with the online vendor.

9. The method of claim 7, wherein the producer gives the item to the online vendor.

10. The method of claim 7, wherein the producer offers the item exclusively to the online vendor during the survey of the online consumer.

11. The method of claim 1, wherein the item is a snack food product.

12. The method of claim 1, further comprising the steps of:
performing offline sustainability testing; and
comparing the results of the online and offline sustainability testings.

13. The method of claim 1, wherein the questionnaire is a CGI script, JAVA, or PERL applet.

14. The method of claim 1, wherein the first response to the questionnaire is transmitted over the distributed network.

15. The method of claim 14, wherein the first response to the questionnaire is transmitted in XML.

16. The method of claim 1, further comprising the step of assigning an identifying code to the user, wherein the first response and the subsequent response(s) are associated using the identifying code.

17. The method of claim 16, wherein the identifying code is a cookie.
